(19) United States
(12) Patent Application Publication
(10) Pub. No.: US 2008/0109557 A1
(43) Pub. Date: May 8, 2008

(54) Method and system for reducing switching delays between digital video feeds using personalized unicast transmission techniques

(76) Inventors: Vinay Joshi, Santa Clara, CA (US); Jayakumar K. Muthukumarasamy, Dublin, CA (US); Rajiv Malik, Sunnyvale, CA (US)

Correspondence Address: PERKINS COIE LLP, P.O. BOX 2168, MENLO PARK, CA, 94026, US

(21) Appl. No.: 11/703,529

(22) Filed: Feb. 6, 2007

Related U.S. Application Data
(60) Provisional application No. 60/856,073, filed on Nov. 2, 2006.

(51) Int. Cl. G06F 15/16

(52) U.S. Cl. 709/231

(57) ABSTRACT

Multi-media and video content distribution and transmission scheme. Method and system for reducing video media channel switching delays that might conventionally occur between different digital video feeds using a personalized unicast video distribution and personalized transmission techniques. Method and system for performing a unicast channel change operation between a client and a server coupled with the client. A fast channel change appliance.

### CROSS REFERENCE TO RELATED APPLICATIONS

This application claims priority under 35 U.S.C. §119(e) to U.S. Provisional Application No. 60/856,073 entitled “Method and System for Reducing Switching Delays Between Digital Video Feeds Using Personalized Transmission Techniques” and filed Nov. 2, 2006; which application is hereby incorporated by reference.

### FIELD OF THE INVENTION

This invention pertains generally to multi-media and video content distribution and transmission schemes and more particularly to a method and system for reducing video media channel switching delays that might conventionally occur between different digital video feeds using a personalized unicast video distribution and transmission techniques.

### BACKGROUND

Presently, digital video applications (such as digital TV broadcasts, music broadcast, video advertisements, and multi-person video conferencing) all use compressed digital video at its core. For example, compression technologies such as ITU-standard Motion Picture Experts Group (MPEG) or Microsoft's VC-1, or Apple's QuickTime are some of the bases of majority of the schemes in use today. Most of these technologies use compression schemes where not all the frames contain full-pictures that can be decoded stand-alone. Some frames (for example, two frames out of thirty frames, in the case of a common MPEG-2 specification) contain full pictures whereas other frames merely contain “differential” data—i.e., information changes between complete pictures. This is how compression efficiency is achieved and how vast amounts on video or picture information is transmitted using minimum bandwidth.

These types of encodings, however, introduce some significant issues in certain common use cases. For example, consider the act of switching television (TV) channels on a digital television system or network versus in an analog television system or network. In the case of analog television systems, this switching would be instantaneous because each frame includes the complete picture information. However, in the digital counterpart, depending on the instance in time, the new channel the user selects or switches into may not (usually will not) have a complete frame for the client (for example, for the television set-top box or other receiver) to start decoding the frame—the data might be differential in nature and without a base reference (e.g., a complete frame of data), the decoder is unable to decode the data stream, until a complete frame of data arrives. Depending on how the picture is encoded, the next complete frame of data may arrive in a few milliseconds or in few seconds. Additional time delays are typically introduced in the various processing that happens within the network. For example, tuning to a channel in a digital Internet Protocol network (IP network) incurs what is called network multicast join (Internet Gateway Multicast Protocol (“IGMP join”)) delays. Cumulatively, all of these delays add up and in certain situations become unacceptable—the user experiences a long delay in going from one channel to another.

In order to achieve higher compression efficiencies for video broadcasts, certain compression schemes and specifications allow for “stand-alone frames” (sometimes referred to as I-Frames for Intra Coded frames, or RAPs for Random Access Points) to be spaced out farther. All other frames are predicted using forward prediction (called P-frames where the “P denotes prediction) or bi-directional prediction (called B-frames where the “B” denotes bi-direction). In these schemes, specifications, and techniques, the predication is the key to achieving better compression; however, the resultant frames cannot be decoded independently. For example, the H.264 video codec used in MPEG-4 Part 10 implementation (See MPEG-4 ISO/IEC 14496 specification in effect as of the date of this filing which is hereby incorporated by reference) allows I-frames or Random Access points to be spaced out as far as 2 to 8 seconds apart. The resultant digital video is “efficient” in terms of the amount or number of bits used to represent the scenes. However, channel change latency becomes significantly longer as it takes decoder a larger amount of time (longer time period) to get a standalone picture that does not require any frames from the past or future to start decoding. The resultant system performance may frequently become unacceptable in terms of user experience.

Conventional Internet Protocol Television (IPTV) networks implement broadcast TV using a technique called Internet Protocol Multicast or IP multicast. IP multicast allows a single source of data to be distributed to all clients in the network. Client here may refer to the device receiving the IPTV channel or content, or to the software executing on that device, and/or to a combination of these. The client may also be associated with a human user, customer or viewer. To constrain the network resources required to support IP multicast, interested clients must request the data from the network. This mechanism is called joining the multicast (or Internet Gateway Multicast Protocol JOIN or more simply “IGMP JOIN” in technical jargon).

In an IPTV network, each broadcast TV channel corresponds to a unique multicast address. When a client switches from one TV channel (or content source) to another TV channel (or content source), the client typically leaves the first channel (by issuing an IGMP LEAVE request) and then joins the second channel (by issuing an IGMP JOIN request). The network responds to the IGMP LEAVE request by stopping the data corresponding to that TV channel from reaching the client. This or these processes, that is the combination of the IGMP LEAVE and IGMP JOIN process, can take time and increases the time required to change from one channel to another channel.

The client device may include a media decoder that is responsible for decoding the program or media content. In addition to the time required to change channel described above, every time the client switches from one channel (e.g., the first channel) to another channel (e.g., the second channel), the media decoder in the client device needs to go through the following process (or something similar) before it can start to display the data for the second channel even when the data is being sent from its source:
(1) Clear all data corresponding to the first channel from the client devices storage or memory buffers.
(2) Buffer enough data for the second channel such that the data includes at least a stand-alone frame (SAF), key frame, Random Access Point (RAP), Instantaneous Decoder Refresh (IDR) frame or I-Frame (Intra Coded Frame) plus relevant meta-information including for example, one or more of the Program Specific Information/Program Clock Reference (PSI/PCR).
(3) Wait for enough data to be available so that the media decoder doesn't underflow or run out of data to decode while decoding the media stream. In the case of H.264 this wait for a threshold of data to be available is controlled by the profile and level being used.
(4) Decode and display the frames on a display screen or component of the client device or attached to the client device.

Conventional approaches attempting to solve these problems and limitations have been unsuccessful. Some of these attempted solutions are now described so that both the problems and limitations as well as the inventive solution may be better understood.

Certain terms, abbreviations, and acronyms are now set forth and are intended to conform to generally accepted usage in the field. They are set forth here for the convenience of the reader. Table 1 sets forth certain abbreviations, terms, and phrases that are used in the description to follow. Some apply to the conventional systems and methods, some apply to the inventive system and method, and some apply to both. They are provided in this section for convenience.

TABLE 1
Abbreviations - Terms - Phrases

| Abbreviation | Description |
|---|---|
| FCC | Fast Channel Change |
| FCC Server | Kasenna's implementation of server for Fast Channel Change |
| Rn | Random Access Points |
| Cn | Clients joining the channel |
| Ti | Time when channel change request is initiated at the client device (e.g. a |
| | button press on remote control) |
| T | Time when a IGMP leave succeeds |
| Tld | Time delay to succesfully leave a multicast channel using IGMP leave |
| Tj | Time to succesfully join the new channel using IGMP join |
| Tjd | Time delay to join the new channel |
| Trap | Time when the first RAP (or SAF) is received |
| Trapd | Time delay to receive the first RAP (or SAF) |
| Tr | Time when client request to join the channel is received on the FCC |
| | server |
| Tp | Time when new channel is rendered on the client device |
| Ts | Time to stream PCS for the client starting with a RAP (or SAF) |
| Rc | Previous RAP encountered in the channel when a client attepmts to join |
| | the channel |
| Tccrd | Time delay between channel change request initiation at client to |
| | reception of channel change request |
| Tswd | Time delay to create a Personalized Channel Stream for the client, and |
| | switch it to the new stream |
| Tpd | Time delay in presenting new channel (Presentation Delay) |
| Tccd | Total time delay for channel change |
| Throttling | The process by which the bitrate of the stream is kept constant over a |
| | period of time T, even though within time T, the instantaneous streaming |
| | bitrate could be increased or decreased in a controlled fashion. |
| Client, Client | All refer to a software or hardware or a combination of both, used as a |
| device, STB | client of the FCC server or appliance. |
| (Set Top Box) | |

There are a few approaches that have been used in an attempt to solve or reduce the afore described problem and the delays that accompany the problem. These attempts have not been entirely successful and in particular have not reduced the delay to an amount of time that is acceptable to a user or viewer without detracting from the user viewing and channel switching experience.

The first and simplest attempt has been to digitally encode the video with stand-alone frames (such as for example, key frames, I-Frames or Random Access Points or RAPs) that are spaced closer together than conventional standards or industry norms might have required. For example, in the MPEG-2 specification used in Digital Video Broadcast (DVB) standards, the I-frames are spaced out or separated 500 millisecond (500 msec) apart. Thus, when a media decoder or more simply decoder starts receiving data for a new channel upon a new channel selection having been made, the worst-case latency or delay scenario to begin decoding the new channel media stream is this 500 msec+the rest of the overhead (including, for example the IGMP leave and IGMP join delay or latency). The rest of the overhead may further for example include or consist of delays in recognizing the remote control key press by the viewer and the time it takes to issue an IGMP join, and may be as long as a few microseconds to several milliseconds, or possibly even longer. However, as described elsewhere herein, this conventional scheme and attempted problem solution does not yield the most efficient media or video streams in terms of the amount of data used to represent the scenes. They also may not reduce the latency or delay to a level that provides a good channel change transition or viewing experience.

FIG. 1 shows the channel change time for typical existing approaches. The total time to channel change (Tccd) is given by the expression:

Tccd=Tld+Tjd+Trapd+Tpd

so that the total time to channel change is given by the additive sum of Tld, Tjd, Trapd, and Tpd, where Tld is the time delay to successfully leave (using for example, an IGMP-leave) a multicast channel using IGMP leave, Tjd is the time delay to join the new channel, Trapd is the time delay to receive the first RAP, and Tpd is the time delay in presenting new channel. This total time delay for channel change Tccd may typically be anywhere from about 2 seconds to about 5 seconds (or more) to switch or change from one channel to another channel.

One strategy applied in an attempt to overcome the latency is to decode the stream and re-encode the stream such that when a client joins a channel, the data always starts with a standalone frame (SAF). This scheme requires significant server processor resources, such as significant server central processing unit (CPU) resources, for decoding and re-encoding the data and may usually introduce significant additional bandwidth overhead requirements because more full or standalone frames, such as I-frames, are generated and have to be transmitted to the network and/or to clients (for example, the resultant data rate may go up from about 50% to 100% or more compared to the original data stream that had fewer standalone frames). Another disadvantage of this scheme is that it may not usually be compatible with features such as encryption because decoding requires access to encryption keys and re-encoding requires access to the original encryption scheme. Both of these requirements are impractical and introduce significant security issues.

Another alternate strategy or attempted solution to the problem, is a hybrid solution approach in which a client that is interested in joining a new channel could start with a unicast stream first to reduce the latency of the channel change and then switch to a multicast stream at an appropriate point in the future. A unicast stream or model is a unique stream that is allocated for each individual user, and is different as compared to a multicast stream or model that provides the same data stream that a multiple number of subscribers to that channel join and share. The unicast stream will need to start with a complete I-frame or RAP so that the client can start decoding the video data without any delay. However, a unicast stream model requires a lot of server and network resources and is not very cost effective. For example, in a very large network, each user may advantageously be assigned a dedicated bandwidth.

However, for this hybrid solution to work well, the client also needs to buffer enough data so that the transition from unicast to multicast can take place without any artifacts. Artifacts such as jitter, frozen frame, or black screen may typically result from transitioning at a non-RAP boundary or from lack of data. Client device buffer requirements may vary depending for example on bitrate of the data or content, the distance or time separation between two RAPs, and/or on other factors. This implies that the unicast stream would need to be sent faster than the bitrate of the channel to build up or fill the buffer on the client. The burden of a channel change or switch from the unicast stream to the multicast stream would be on the client. This would require a smart (or smarter) or intelligent client than for a multicast scheme (with the resulting greater client device cost) whereas it is preferred to only require a less smart, thin, or less intelligent client. Moreover, the data or media content viewed by any client under this scheme will always be delayed and the maximum delay would roughly equal the time between two RAPs.

It may therefore be apparent that there remain problems and limitations in the conventional art that have not been solved or overcome by these attempted solutions.

### BRIEF DESCRIPTION OF THE DRAWINGS

FIG. 1 is a diagrammatic illustration showing a typical conventional channel change timeline.

FIG. 2 is a diagrammatic illustration showing aspects of an embodiment of a IPTV Network according to the invention.

FIG. 3 is a diagrammatic illustration showing aspects of an embodiment of a DSLAM Interconnection Network according to the invention.

FIG. 4 is a diagrammatic illustration showing an exemplary network configuration diagram depicting the proposed channel change scheme

FIG. 5 is a diagrammatic illustration showing a diagram for channel change timeline in an embodiment of the inventive personalised unicast approach.

FIG. 6 is a diagrammatic illustration showing a diagram to depict the personalised unicast stream creation procedure.

FIG. 7 is a diagrammatic flow chart illustration showing an embodiment of a personalized transmission technique approach.

### SUMMARY

In one aspect, the invention provides system, method, and computer program for reducing media channel switching delays between different digital video feeds using a personalized transmission technique.

In another aspect, the invention may provide a method comprising the steps: receiving a channel change request from a client; determining client properties in response to the received request; identifying the nearest RAP as nRAP; identifying the nearest PCR as nPCR and the nearest sequence parameter set (SPS) as nSPS; determining if Dist(nRAP,nSPS) is greater than Dist(nRAP, nPCR); if Dist(nRAP, nSPS)>Dist(nRAP, nPCR) then find the nearest PSI (as nPSI) from nSPS and otherwise find the nearest PSI (as nPSI) from nPCR; generating a personalized channel stream for the client with optional switch data; and initiating streaming data from nPSI for the client.

In another aspect, this method may include using throttling to reduce client buffering delay on the client.

In another aspect, embodiments of the invention provide a method for reducing media channel switching delays between different digital video feeds, the method characterized in that: the method provides a personalized unicast distribution using a personalized transmission technique from a server to a client; and the server changes the media channel in response to a request for channel change from the client.

In another aspect, embodiments of the invention provide a method comprising: receiving a channel change request from a client; determining client properties in response to the received request; identifying the nearest RAP as nRAP; identifying the nearest PCR as nPCR and the nearest sequence parameter set (SPS) as nSPS; determining if Dist(nRAP, nSPS) is greater than Dist (nRAP, nPCR); if Dist(nRAP, nSPS)>Dist (nRAP, nPCR) then find the nearest PSI (as nPSI) from nSPS and otherwise find the nearest PSI (as nPSI) from nPCR; generate a personalized channel stream for the client with optional switch data; and initiating streaming data from nPSI for the client.

In another aspect, embodiments of the invention provide a system comprising: an edge router receiving broadcast data from an external broadcast data source; a fast channel change (FCC) server coupled to the edge router via a r-link; a DSLAM coupled to the FCC server; and the FCC server and the DSLAM interfacing to a client via a subscriber network.

In another aspect, embodiments of the invention provide a method for performing a unicast channel change operation between a client and a server coupled with the client, the method comprising: sending first data over a first channel by a server to a client; receiving first data over a first channel by the client from the server; while the client is receiving the first data for the first channel, the client sending a channel change request to the server, to request a change to a second channel and second data different than the first channel and first data; receiving the channel change request by the server; in response to receipt of the channel change request, the server stopping sending first data on the first channel, and initiating sending second data on a second channel to the client; receiving the second data on the second channel by the client from the server in response to the request to change channel sent to the server.

In another aspect, embodiments of the invention provide method for performing server-side unicast channel change operation between a client and a server coupled with the client, the method comprising: sending first data over a first channel by a server to a client; receiving the channel change request by the server; and in response to receipt of the channel change request, the server stopping sending first data on the first channel, and initiating sending second data on a second channel to the client.

In another aspect, embodiments of the invention provide a method for performing a client-side unicast channel change operation between a client and a server coupled with the client, the method comprising: receiving first data over a first channel by the client from the server; while the client is receiving the first data for the first channel, the client sending a channel change request to the server, to request a change to a second channel and second data different than the first channel and first data; and receiving the second data on the second channel by the client from the server in response to the request to change channel sent to the server.

In other aspect embodiments of the invention may provide system comprising: a channel change appliance for coupling to a network and receiving an encoded data stream from the network; a second appliance performing a function of a Digital Subscriber Line Access Multiplexer (DSLAM) receiving the communicating a plurality of output data stream to a plurality of client devices, at least one of the output data stream communicated to the plurality of client devices being a personalized unicast output data stream communicated to a particular one of the client devices; a switch or router coupled to the channel change appliance for switching or routing at least one data stream to the second appliance; and a communication link between the channel change appliance and the client device for communicating a channel change request signal identifying a request channel or data stream.

In other aspect embodiments of the invention include system and computer program for carrying out the method and procedural portions of the method.

### DETAILED DESCRIPTION OF EXEMPLARY EMBODIMENTS OF THE INVENTION

Embodiments of the invention provide systems, devices, methods, procedures, and/or computer programs and computer program products associated with a channel change operation that may usually involve a request in an interaction between a server, providing data, video or other multi-media content, and a client that receives this data or content. These systems, devices, methods, procedures, and/or computer programs and computer program products reduce the switching delays or latencies between digital video or content feeds and/or channels using what may be referred to as personalized transmission techniques, procedures, and algorithms.

The phrase personalized transmission techniques may be applied here because this approach uses a dedicated transmission connection using a unicast transmission model to a particular client device or subscriber using that client device. Usually, the unicast transmission may be directed to a unicast address or; port associated with the client device, but the unicast data stream may alternatively be directed to and received by the client at its multicast address or port. For this reason, although the system and method are directed to a personalize distribution and transmission of media content, particularly of digital video content, the system and method support both unicast and multicast destination address distribution. The connection (to either a unicast address or a multicast address in the client device) is specific to a client and may be used to provide per client specific or client specific customized and/or personalized services or features. This technique may also use optional but advantageous bitrate or data throttling to reduce the channel change delay without increasing the overall streaming bitrate. Throttling is a process by which the bitrate of the stream is kept constant (or approximately or substantially constant) over a period of time T, even though within time T, the instantaneous streaming bitrate may be increased or decreased in a controlled fashion. This constant or approximately constant or substantially constant bitrate over a period of time T, may for example be represented by the average or mean bit rate being constant or substantially constant over that time period.

The above described problems in the conventional arts and the path to a solution to these problems may be stated in an abstract form as follows. It should be possible to switch between two different video streams (streams that are encoded differently) such that the switching can occur near instantaneously. Nearly instantaneously in this context means for example that the change or switching occurs within a configured/specified time limit or bound, so that it is possible to predict the maximum channel switching delay. The maximum channel switching delay will then be equal to the sum of delay introduced by the client to issue a request to change the channel plus the delay to buffer enough data for the next channel.

The various embodiments of the invention as described herein provide solutions to the afore described conventional system and method problems and limitations, and this inventive solution may be applied to a number of varied and different technology and market segment requirements. Some of the features and aspects of the invention as they apply to various technology and market segment requirements and features are described below by way of example, but not by way of limitation.

In a first aspect, embodiments of the invention may provide a near-instantaneous changing of channels on a digital television system or other video or media content delivery system.

In a second aspect, embodiments of the invention may provide for fast switching or changing between a broadcast video stream and an on-demand video or media stream, or between any other two or a multiplicity of different streams.

In a third aspect, embodiments of the invention may provide an ability to introduce advertisement content (or ad content) into a digital video system in a way that the advertisement content can be or is “personalized”. By personalized is meant that each user or some identified group or set of users with similar interests (or targeted as a similar interest group or according to other targeting criteria) are delivered and shown an advertisement from a collection of advertisements that match their interest profile or some other interest criteria.

In a fourth aspect, embodiments of the invention may provide a multi-user video conferencing system, method, or support structure or component, in which it is possible to switch or change between different members, participants, or users of the video conference system (or their camera video and audio streams showing: such participants) instantaneously or substantially instantaneously.

In a fifth aspect, embodiments of the invention may provide a multi-user or multi-gamer video game system in which it is possible to switch between and among different users or gamers instantaneously or substantially instantaneously.

In a sixth aspect, embodiments of the invention may provide system, architecture, and method having an ability to provide services based on client profiles and/or preferences. Non-limiting examples of such client profile or preference based services may include any one or combination of the following. (A) A mosaic of video or other multi-media including images or video such as, showing N different broadcast channels in one screen at a reduced size. A user can then select the broadcast channel to watch. Thus, the user can see a preview of a channel before tuning to it. This may have particular advantages where a payment may be required to receive and view a full resolution or full screen version, but a preview may either be free, free for a longer period of time, or available at a reduced payment rate relative to a full resolution or full screen. It also advantageously may permit multiple simultaneous previews so that a potential viewer may make a choice or selection more readily. (B) This same model (as above) may be used for watching Video-On-Demand (VOD) previews of more than one movie or other content at a time. (C) As a third alternative, this same model (as above) may be used to deliver and show the EPG (Electronic Program Guide) or other such program guide information with previews of each channel or content source.

Other features and aspects of embodiments of the invention are described elsewhere in this detailed description and/or shown in the drawings.

Embodiments of the invention may also or alternatively be applied to other video or media content such as surveillance, security, gaming, or other situations where it is desirable to be able to switch or change between different video or media content, or to present multiple different video or content without excessive delay or latency or viewing artifacts.

These features, aspects, and/or advantages provide significant solutions to the problems and limitations in the conventional arts. In arriving at these solutions, an engineering design approach was taken having the following engineering design and performance goals. These design goals are not to be interpreted as requirements or limitations of the invention or of any particular embodiments of the invention. Rather they were goals for the engineering design and these goals contributed at least in part to the inventive solution as revealed in the various embodiments.

First, a solution to the problem would advantageously require minimal or no intelligence or capability to be added to the client device, allowing any standard client device that might have been used with conventional digital video (such as Digital TV) to access the services of the inventive implementation with minimal or no change. Minimal change might for example require or be limited only to a software or firmware upgrade. Second, a solution to the problem would advantageously provide an algorithm or procedure that is “bounded”—that is where the load on the system implementing the problem solution needed to be no more than a constant multiple of the number of channels. Third, a solution to the problems and limitations of conventional systems and methods may advantageously provide a method and algorithm that has an upper bound on the configurable worst-case channel switch latency. Fourth, there was at least a recognition of a desirability that the solution not impose any overhead on the network, or at least not any uncontrolled overhead on the network, in terms of requiring higher uncontrolled data rates at the link connecting the user or client to the network. Fifth, it was desirable that any solution not to impose any restriction or at least no significant restriction, on the features available to the stream, such as an ability to use encryption or other security mechanism.

In recognition of these design goals, at least two embodiments of a solution are provided that use a unicast personalized transmission technique that solves the problem. Embodiments or a unicast personalized transmission technique are described below.

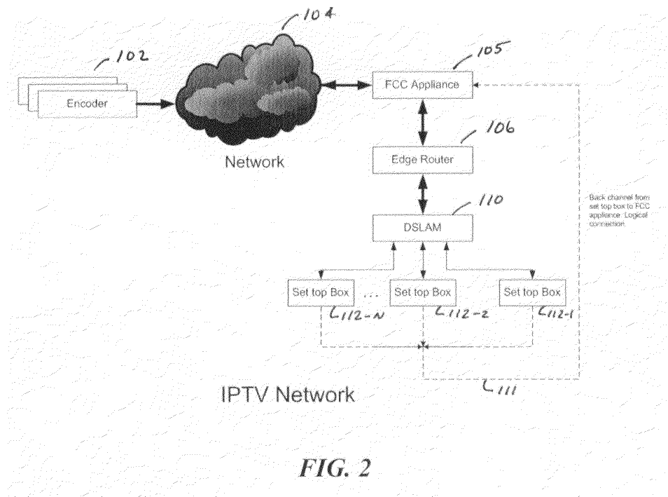

FIG. 2 shows a non-limiting exemplary embodiment of an Internet Protocol television (IPTV) Network system 100. In one non-limiting embodiment, an encoder 102 for encoding digital TV or other program content is coupled to a network 104, such as for example to the Internet, an intranet, or to any other interconnected set of computers, information appliances, or other devices as are known in the art or to be developed. The encoder communicates a content stream to the network so that it may be communicated to one or more destinations. The Fast Channel Change (FCC) server or appliance 105 is coupled with the network 104 and configured to receive the encoded content. The FCC server or appliance (which may include or be a server or an appliance having some server attributes) is also coupled with a router, such as an edge router 106. The FCC appliance receives channel tuning or selection requests from one or more different set top boxes or other client devices (usually many such set top boxes or other client devices) and transmits a different stream to each set top box 112. A Digital Subscriber Line Access Multiplexer (DSLAM) 110, or equivalent device or system incorporating the function of a DSLAM, receives the different unicast streams from the FCC appliance or server. The DSLAM 110 or equivalent device or system which is located relatively close to the digital TV or other content subscriber and client receiver device, such: as a TV or content display set top box, communicates the content to the subscriber-receiver device, such as the set-top box 112. A back channel 111 from the set top box to the FCC appliance or server provides a logical connection between the client (for example, the set top box) and the FCC appliance so that a request for a channel or data stream change may be communicated from the client to the FCC. In at least one non-limiting embodiment this back channel communication link may be the same physical path as the communication path over which data is set to the client. In at least one different non-limiting embodiment this back channel communication link may be a different physical path as the communication path over which data is set to the client.

It is known in the art that a DSLAM (Digital Subscriber Line Access Multiplexer) is typically a network device, usually at a telephone company (Telco) central office, that receives signals such as a data stream from multiple customer Digital Subscriber Line (DSL) connections and puts the signals on a high-speed backbone line using multiplexing techniques, and performs the reverse operations for signal transmission from the backbone to the subscriber end user. Depending on the product, DSLAM multiplexers connect DSL lines with some combination of asynchronous transfer mode (ATM), frame relay, or Internet Protocol networks. The use of DSLAM enables a telephone company or other data provider to offer business or homes users relatively fast phone line based technology (DSL) with the fast backbone network technology (ATM).

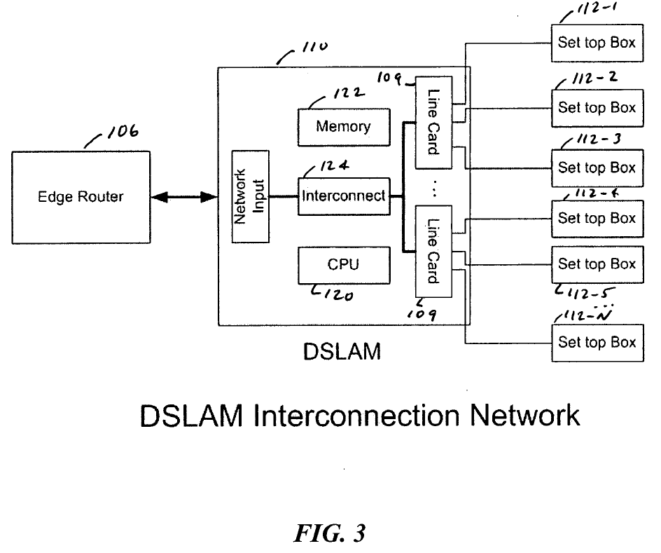

FIG. 3 is an illustration showing a downstream portion of the IPTV or other content distribution system of FIG. 2, including additional detail of the DSLAM or equivalent device, system, or component. DSLAM 110 receives a multicast media content stream from edge router 106 as a network input to a network input of the DSLAM. The network input may be some type of network interface card (NIC) or equivalent as may be known in the art. DSLAM 110 also provides interconnect circuitry or logic coupled between the network input and a plurality of line transmission circuits, typically in the form of line cards 109 that are used to communicate the encoded content received from the edge router to a plurality of content destinations, such as to a plurality of subscriber receiver devices, such as to a diverse plurality of subscriber devices in subscriber homes, businesses, or the like destination locations. The communication between the DSLAM, and an output of the line card, is essentially a point-to-point connection to the subscriber destination as is known in the art.

DSLAM may also include some form of processing logic 120, such as a processor, central processing unit, ASIC, or other logic. The processing logic may include internal random access memory and/or be coupled to separate memory 122. Additional non-volatile memory (not shown) for storing programs, parameters, or other data or information may optionally be provided. Some conventional features of DSLAMs as are known in the art are not shown to avoid obscuring aspects of the invention.

Non-limiting embodiments of the invention provide control and switching logic to modify or control the operation of the DSLAM interconnect unit 124 so that the signals received by the interconnect from the network input are modified in accordance with the methods, procedures, and/or algorithms of embodiments of the present invention. As described elsewhere herein, non-limiting embodiments of the invention generate a Personalized signal or data stream from a single signal or data stream. Embodiments of this method are referred to as the personalized transmission technique. Each personalized data stream or signal are communicated to a subscriber device (such as one of the set top boxes) entitled to receive it so that in the event that subscriber chooses to change the channel, the data for the new channel is spliced or integrated into the same data stream or signal the subscriber device is receiving for nearly instantaneous and artifact-free viewing or substantially artifact-free switching. The method, procedure, algorithm, and selection, decision and creation criteria as to which of the plurality of original multicast channels to select and to create personalized signal or data stream based on it, are described elsewhere herein.

It may also be appreciated in light of the description provided here, that although a wired network serves as a primary basis for description of the inventive system and method, that the inventive system and method may also or alternatively be applied to wireless communication systems and networks. For example, a wireless transmission tower or other wireless communication system as are known in the art, may serve the functionality of the DSLAM and may therefore be considered an equivalent of the DSLAM. This may include cellular telephone type wireless systems and towers, WI-FI type wireless systems and antennas, WI-MAX type systems and methods, or the like. Such a wireless transmission tower or communication system may for example provide wireless point-to-point communication links to a plurality of wireless stationary or mobile subscriber devices. Subscriber devices may for example include, but not be limited to, cellular or wireless telephones, computers, personal data assistants (PDAs), wireless set to boxes or receivers, and/or any other device or information appliance capable of receiving such wireless transmission. A subscriber may utilize their device to select and switch to a different channel in a manner similar to that described for a wired system.

One non-limiting embodiment provides a system, architecture, and method that incorporate design elements referred to as a Personalized Transmission Technique (PTT) streaming approach and implements channel change or switching by having or providing a server that implements fast channel change and is referred to as a Fast Channel Change Server (FCC Server) that may act as a server and as a switch between the broadcast channels and the plurality of different clients.

In this unicast Personalized Transmission Technique approach or scheme, the client establishes a unicast channel connection using the client device unicast address or port with a server, such as with the FCC Server, to receive the broadcast TV (or to receive other digital media stream if different from broadcast TV). The client and server may alternatively establish a channel connection using the client multicast address or port if preferred as either the unicast or multicast address or port typically have the same connectivity and bandwidth capabilities, and it is primarily an address number range convention that identifies the port or address as unicast or multicast. As part of setting up the connection (using either the unicast address or multicast address) with the FCC Server, the client requests the FCC Server to send the data corresponding to a default broadcast channel. The default broadcast channel may vary or be different from client to client and/or from time to time. For example, the default channel may set or established to be the channel that a particular client watched last, or a default channel selected by the client, or any other default channel in any other way, and may even be randomly determined.

The client (or viewer or user controlling the client) then makes a channel selection. Based on the client's selection, the FCC Server switches or changes the data corresponding to the specific selected broadcast channel to the given client. (It may be appreciated that in accordance with one optional optimization or enhancement, if the selected channel is the same as the default channel from which the client is receiving data, there is no need to change or switch channel. When the client needs to switch from one channel to another channel, it does so by sending the channel change request upstream from the client to the FCC Server. The FCC Server responds by seamlessly splicing the data for the second channel with the data for the first channel. From a client perspective, the client does not need to leave the first channel and join the second channel. Consequently, the problems that occur in conventional systems and methods using multicast IGMP LEAVE and IGMP JOIN and their delays do not occur.

In at least one non-limiting embodiment, the client only sees a change in the program definition and not any stop or restart of data. The client does not see any stop and restart of data because as described in greater detail herein below, the server may optionally indicate to the client such as by sending a message, signal, or the like, at the time of channel change, that the current program has ended and a new program is starting; or a client device may be configured to automatically identify the channel or program change so that this indication is not required. As a result, much of the client overhead that corresponds to starting up a new channel after a channel change is avoided.

A Fast Channel Change appliance or server (FCC Server) may optionally but advantageously use or implement data stream bitrate throttling to further reduce the channel change delay. For example, throttling may be applied within two Random Access Points (RAP) of other stand-alone frames, where FCC Server sends the data at a pre-defined or pre-configured rate (normally higher than the bitrate of the content) for a short duration of time and then sends the data until the next RAP point at a lower bitrate. Thus using this optional bitrate throttling enhancement, the desired average or required overall bitrate of the content is maintained within two consecutive RAP points. The duration and/or the amount of data the FCC Server sends at a higher rate are configurable, thus allowing the tuning of throttling to provide an optimal reduction in channel change delay. The configuration may be either predetermined, dynamically determined, or determined in any other way to achieve an optimum or a desired and achievable reduction in channel change delay.

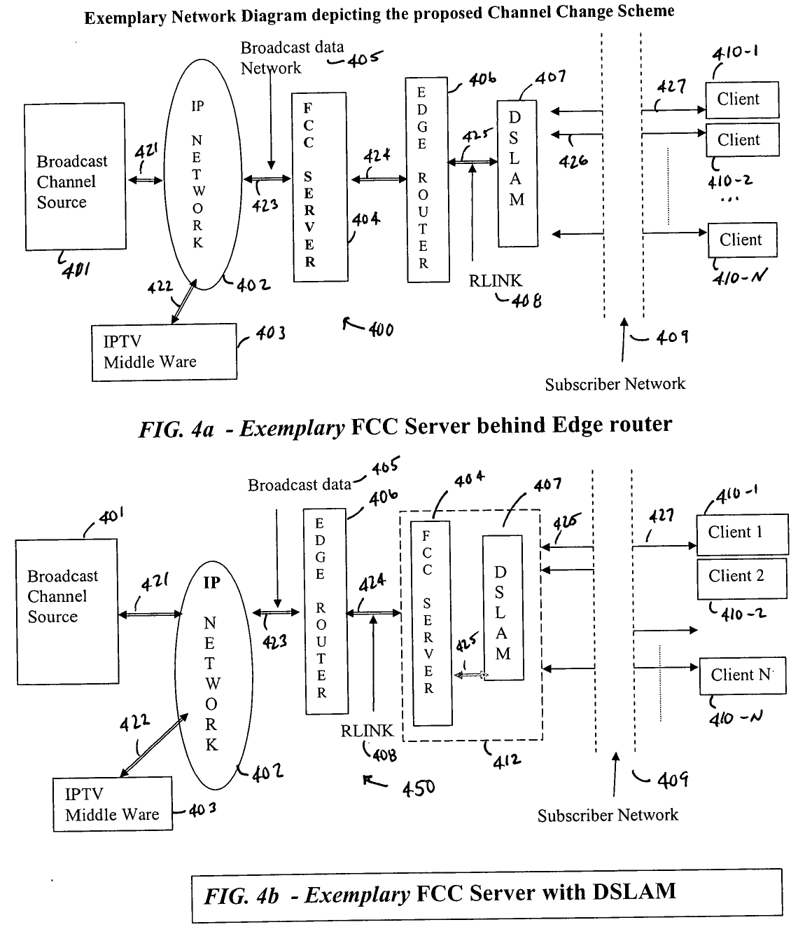

FIG. 4 (including FIG. 4a and FIG. 4b) is an illustration showing an exemplary non-limiting embodiment of a network architecture that may be used to implement fast channel change operation. Conventional features that may tend to obscuration of embodiments of the invention are not shown. The fast channel change or FCC Server represents an exemplary implementation of this approach and method, but other different servers or server architectures or structures may be utilized that provide the requirements identified herein. It may therefore be appreciated in light of the description provided here, that the FCC Server may take the form of, or be implemented in, any one or more of a variety of ways, such as for example by using a specialized Digital Subscriber Line Access Multiplexer (DSLAM) or equivalent device or a separate entity interacting closely with the DSLAM. A data, video, or other media content system and method according to an embodiment of the invention may provide a plurality of FCC servers either to satisfy capacity requirements or for redundancy. When such plural FCC servers are provided they may have the same or different structures or architectures. Provision and integration of plural servers in a network for capacity and/or redundancy are known in the art and not described in further detail here.

An exemplary embodiment of a personalized transmission technique channel change scenario and method is now described. This scenario includes optional steps that are advantageously practiced but not required in all embodiments of the invention. Understanding two conditions or states may assist in understanding the channel change scenario, these two conditions or states are: (i) a startup condition or operation, and a (ii) channel change condition or operation. The startup condition may not be practices in all embodiments and in fact may be seen as an additional and optional procedure relative to the channel change condition or operation.

(1) When the client starts up, is booted, initialized, or the like, it contacts the server, such as a an FCC Server, and establishes a unicast channel connection (using either a unicast address and port or a multicast address and port).

(2) The client then sends a request to the server to receive the data corresponding to a channel, such as to a default channel. (Several alternative exemplary options for assigning a default channel are described elsewhere herein.)

(3) The server responds to the client request by switching (and delivering) the data for the channel, such as for the default channel, to the client.

(4) The client receives a user viewer or subscriber request to change the channel, such as a button-press based command or request from a viewer controlling the client device.

(5) The client identifies or traps the viewer request or command, and forwards or sends the identified or trapped viewer request (or a new client request based on or derived from the viewer request or command) to the server.

(6) The server responds to the viewer or client request by splicing or inserting the data for the requested second channel into the unicast channel for the client that had to that point in time been delivering either a default channel data or a prior selected data channel.

(7) The client sees or recognizes a change in the program definition and does a soft reset of the decoder or otherwise clears the decoder. The soft-reset or other clearing on the decoder flushes the old buffer and stream properties so that data and stream properties that were applicable to the default or prior selected channel are no longer present in the client.

(8) The decoder (and therefore the device itself which includes the decoder) displays data, perhaps after a small pause while initial buffers fill and new stream properties are extracted. After the change of content (and content properties) resulting from the channel change, the media decoder has to wait till the initial buffers are full and the decoder has extracted the new data or media stream properties before the audio/video display of the client device can begin so as to avoid the underflow that may otherwise result in the device not having enough data to maintain smooth playback or rendering of the video or other media.

In one non-limiting embodiment, migrating the broadcast to unicast switching logic may be implemented to reduce potential bandwidth requirements that may in some instances arise from certain implementations of the channel changing method. In this context, it may be observed that analysis of network bandwidth requirements for some embodiments of the inventive system and method, suggest that in at least some embodiments, the channel change scheme described here may somewhat increase the bandwidth requirements on the network or communications link connecting the DSLAM (when this implementation is used) to an edge router at the edge or a network.

This potential increase in bandwidth requirement may be especially true if an edge network is architected as a ring hosting multiple DSLAMs. Edge routers and edge networks are as are known in the art and not described in further detail here. A ring hosting multiple DSLAMs may also be optionally but advantageously utilized. One way to solve this potential bandwidth increase problem is by migrating the broadcast to unicast switching logic from the FCC Server to one or more DSLAM. In this non-limiting exemplary architecture, the DSLAMs receive the multicast data corresponding to the broadcast channels and operate at least in part as a switch to switch the personalized unicast data to the individual clients as required. The link from the edge router to the DSLAM is limited to carrying just the broadcast traffic thereby limiting the bandwidth requirements on that link. (Represented in FIG. 4b).

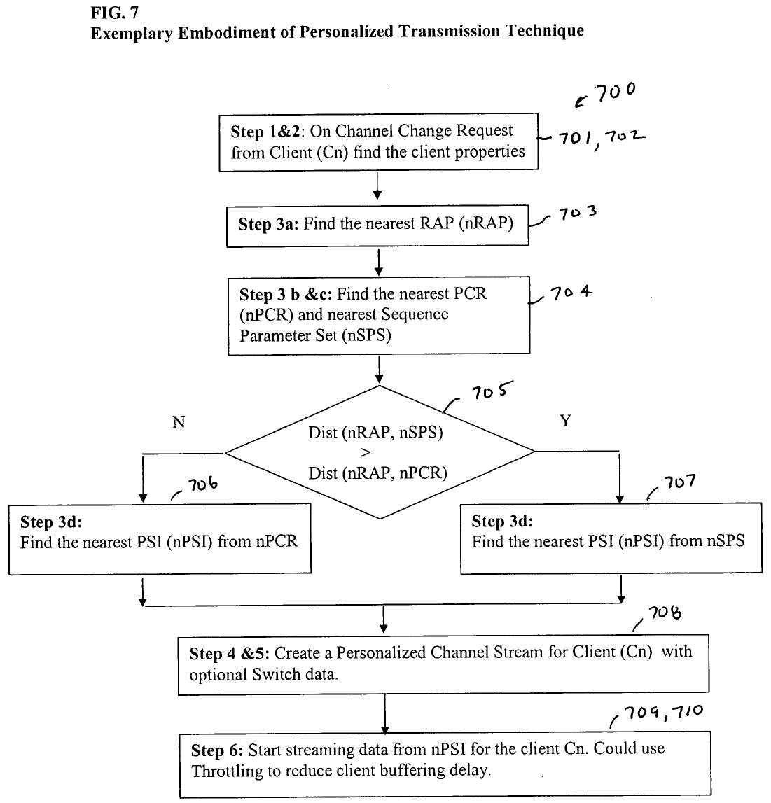

Attention is now directed to an exemplary procedure and algorithm for a unicast personalized transmission technique (PTT) approach. On each channel change request, the following steps are performed, as depicted in FIG. 7. In one non-limiting embodiment of the invention, the following steps may be performed:

(1) A client issues a request to select or tune to a specific channel or content source to the server, such as to a fast channel change server.

(2) From the client request (or from any other predetermined protocol), the server, such as a server configured as a fast channel change or FCC server, determines the client identity and the requested channel. The client identity may be determined by an IP address or other identity information contained within or associated with the received request, or according to other identification types known in the art.

(3) The server, such as the FCC Server, may them perform the following steps or operations:
(a.) The server finds the nearest Random Access Point (RAP) or other stand-alone frame or key in a buffer list for the requested channel (referred as nRAP where the “n” refers to nearest).
(b.) The server find out the nearest previous Program Clock Reference (PCR) in the buffer list with respect to the nRAP (this is referred as nPCR)
(c.) The server finds out the nearest previous Sequence Parameter Set (SPS) in the buffer list with respect to the nRAP (this is referred as nSPS)

(d.) The server finds out the nearest previous Program Specific Information (PSI) in the buffer list from either nPCR or nSPS whichever has greater distance with respect to the nRAP (referred as nPSI).

(4) The server (such as for example, an FCC server or appliance) may optionally indicate to the client such as by sending a message, signal, or the like, at the time of channel change, that the current program has ended and a new program is starting. As described elsewhere herein, a client device may be configured to automatically identify the channel or program change so that this indication is not required. This optional effect, may for example be achieved by sending an indicator in-band or out-of-band, such as for example a soft reset indicator either in-band (that is, within the data channel stream) or out-of-band (that is, via some other communication link or external mechanism). The soft reset indicator may for example, be a simple end of stream indicator and begin of a new program using the existing standards, or a non-standard pre-agreed upon sequence of data that accomplishes the desired messaging. The in-band soft reset indicator will be referred to as the switch data. This switch data may also include the properties of the new stream, such as for example the new channel stream PSI, PCR and SPS. It may be appreciated that these properties of the new stream may alternatively be sent or communicated separately from the switch data.

(5) The server, such as a FCC Server, creates a client customized or personalized channel stream for the client (starting with the optional in-band switch data) at the nPSI found in step (2), and streams the data to the client specific address. Recall that even though this is a unicast distribution or transmission, either a unicast or multicast address may be used, though typically the unicast address may be selected.

(6) The server may optionally use bit-rate throttling as described elsewhere herein, thus sending the initial data required by the client media decoder at a different rate than later data, such as at a pre-configured or even dynamically determined rate. The server may also make sure that the bitrate of the content is maintained within two consecutive RAP units. This throttling advantageously reduces any initial delay at the client in displaying the media (audio/video) but does not impose higher network bandwidth requirements.

The Client detects the soft reset or other program or channel change indicator (in-band or out-of-band) and performs a soft reset of the client device decoder to start decoding with the new properties of the changed data or content media stream.

It is noted that it is possible for a client having sufficient processing capability, such as a client that might be referred to as a smart client, to detect the new data, without any explicit need for a soft reset indicator or any other program or channel change indicator. This way the server (e.g., the FCC Server) is not required to send any soft-reset or other program or channel change indicator to the client.

On startup, or when the client requests first channel data, the client may perform the following:
(1) The client sends or communicates a request to the server, such as to an FCC server, to obtain an address from the server for use in subsequent unicast program delivery and receipt.
(2) The server, based on a predetermined or dynamically determined assignment scheme assigns a unicast address and port (or optionally may use a multicast address and port) to the client.
(3) The client starts monitoring or listening for data on this assigned address/port. In at least one non-limiting embodiment, the client will use the same address/port irrespective of any channel change request or subsequent program or channel change resulting from such request.

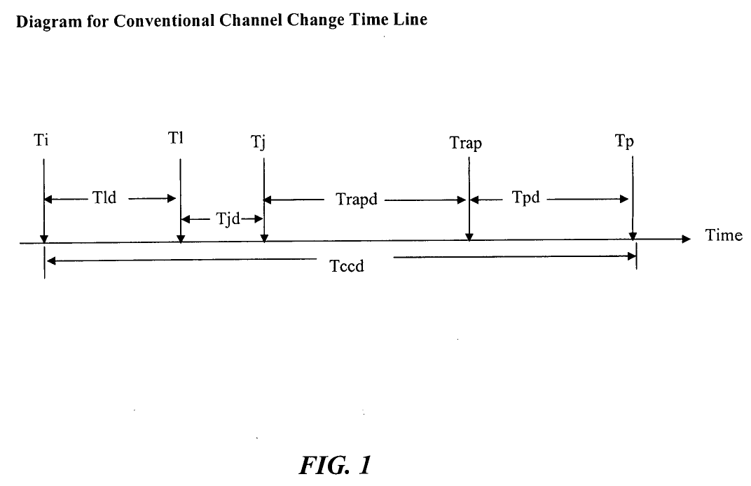

Recall that FIG. 1 illustrated the channel change time and timings for typical existing conventional channel change approaches. In these typical approaches, the total time to channel change was given by the expression:

Tccd=Tld+Tjd+Trapd+Tpd.

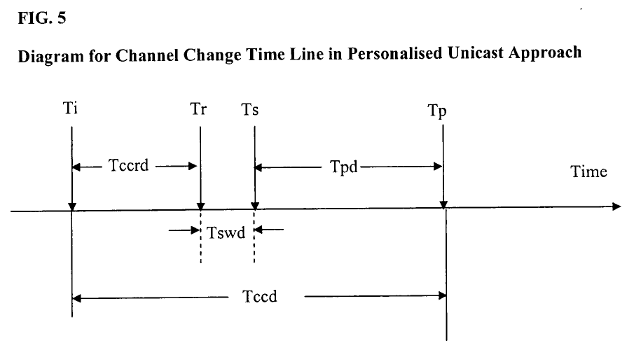

In the illustration of FIG. 5 for embodiments of the present invention, by way of comparison, illustrates the channel change time and timing for an embodiment of the unicast Personalized Transmission Technique (PTT) approach. In this illustrative exemplary embodiment, the total time to channel change Tccd is given by the expression:

Tccd=Tccrd+Tswd+Tpd

where Tccrd is the time delay between channel change request initiation at client to reception of channel change request, Tswd is the time delay to create a personalized channel stream for the client, and switch it to the new stream; and Tpd is the time delay in presenting new channel.

A simple round trip delay given by the expression, is small compared to the Leave and Join delay of a Multicast associated with conventional systems and methods. It reduces the first major component of the delay in the conventional channel change, such as represented by the sum Tld+Tjd in the illustration of FIG. 1 as compared to the time delay between channel change request initiation at the client to the reception of channel change request (Tccrd) in the embodiment illustration of FIG. 5. Since the new channel data advantageously should always start on a RAP (or other stand-alone frame), it eliminates any delay in getting the first RAP unit after starting to receive data. In other words the time delay to receive the first RAP (Trapd) component in FIG. 1 is eliminated.

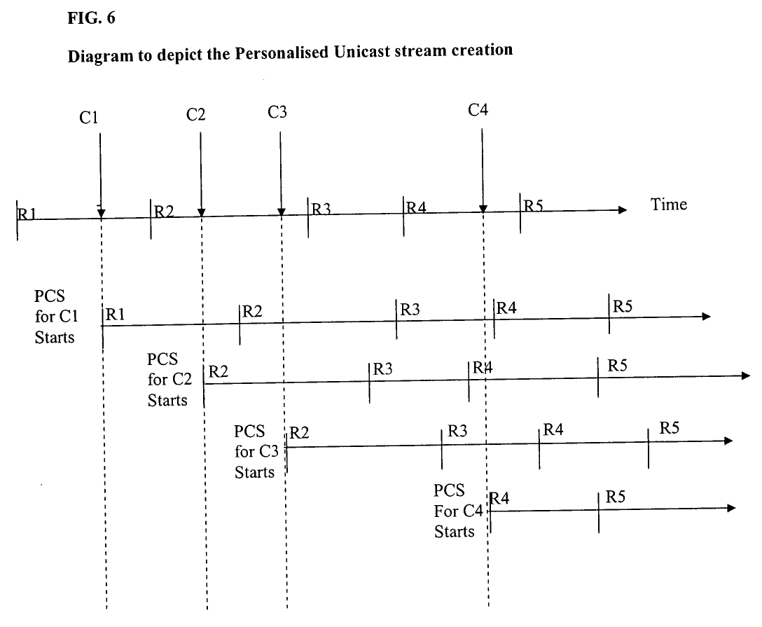

A diagram to depict the Personalized Transmission Technique unicast stream creation for an exemplary embodiment is illustrated in FIG. 6, and shows clients C1, C2, C3 and C4 tuning to the same channel at different times. Client C1 issues the request between RAP R1 and RAP R2, and hence receives the personalized stream from RAP R1. Clients C2 and C3 issue the request between RAP R2 and RAP R3, and receive the personalized stream from RAP R2. Note that both client C2 and C3 receive a unique stream starting at R2. Client C4 issues the request between RAP R4 and RAP R5, and hence receives the personalized stream from RAP R4.

Embodiments of the inventive system and method provide solutions to the conventional problems and limitations and also provide several significant features, enhancements, and advantages over conventional systems and methods beyond reducing delay and artifacts. These may include any one alone or combination of the features listed below. Not all embodiments need include each feature, and features listed below may be optional to certain embodiments and are not required in all embodiments of the invention.
(1) Embodiments of the invention provide that each channel change request will experience a maximum delay or latency of (L), which is determined by a worst case round trip (to indicate channel change) and worst case presentation delay Tpd (or time delay in presenting new channel) for the first RAP unit.
(2) Embodiments of the invention provide that the maximum channel change time using the inventive personalized transmission technique approach is significantly reduced as compared to conventional approaches and in some embodiments is close to about one a second, in other embodiments less than a second or sub-second, in at least one embodiment between about 500 millisecond and 750 millisecond, in another embodiment between 250 millisecond and 500 millisecond, with potentially even smaller delays anticipated as system configuration and tuning are optimized.
(3) Embodiments of the invention provide that for each channel, the size of the buffer (B) in the server that needs to be maintained on the server for buffering the data to be sent to the client is bounded and can be determined from the configuration parameters.
(4) Embodiments of the invention provide that the computational complexity for processing each channel on the server is bounded and can be determined based on the configuration parameters. This computational complexity bounding is advantageous at least because it permits determining server capacity and system and network sizing.
(5) Embodiments of the inventive personalized transmission technique scheme can be readily implemented with minimal logic on the client, so that thin client implementations may be deployed. For example, all that is required on the client is a channel change request identifying itself and the new channel, and ability to perform a soft reset for the decoder to start decoding using new stream properties. These preferences may readily be satisfied by clients having very little processing power or other capabilities. Such clients are lower cost and more affordable to potential subscribers.
(6) Embodiment of the invention provide infrastructure for many per subscriber or personalized subscriber features, such as by way of example but not limitation: personalized or customized advertisement (ad) insertion, pause/resume live TV, nPVR, and other content delivery applications now present or that may arise in the future.

Embodiments of this process or method may be implemented as hardware, as software/firmware, or as a combination of software/firmware and hardware. When software/firmware or other computer program code is included in an implementation, the software/firmware may include instructions and optional data or parameters for execution in a processor logic (such as for example in a micro-processor, central processing unit (CPU), multi-core processor, or any other processing logic) coupled with an internal or external memory. Exemplary non-limiting embodiments of the invention also contemplates a computer program and computer program product stored on computer readable media implementation of the procedures and methods described herein either separately or combined. The computer program may be stored in an electronic form and/or on a computer readable medium. For example, separate computer programs may be provided for server of server side, middleware, and client or client side operations or procedures. Computer programs may be stored on a tangible media for reading and execution by a processor or processing logic in a computer or other information appliance or device as described.

In the exemplary process, method, or computer program for implementing a slotted multicast for a fast channel change or switch, it may be noted that in the steps, describing some of the methods and procedures, Random Access Point or RAP refers to a RAP which advantageously has or includes some meta-information or meta-data such as for example PSI, PCR and other information before the RAP.

It may also be appreciated that a Random Access Point or RAP is one particular type of stand-alone or key frame from which the data frame may be decoded without reference to past or future (other) frames. Other stand-alone frames (SAFs) in current standards include but are not limited to the Random Access Point (RAP), key frames, IDR frame, and an I-frame. The invention contemplates the use of any of these frames and further contemplates other or different stand-alone frames types that may arise in the future. In some instances the term and acronym stand-alone frame of SAF is used, however, as random access point (RAP) type frames or data items are one of the more common stand-alone frame types, the embodiments of the invention have principally been described with this stand-alone frame type in mind and using the RAP nomenclature. It will be appreciated by those having ordinary skill in the art in light of the description provided here that other stand-alone frame types may be used, and that the RAP, nRAP, and associated language is a stand in for and means any of these stand-alone frame or data types. Therefore the term RAP and its related forms such as nRAP are to be accorded the widest possible breadth and include any of the stand-alone frame or SAP types.

As used herein, the term “embodiment” means an embodiment that serves to illustrate by way of example but not limitation. It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

We claim:

1. A method for reducing media channel switching delays between different digital video feeds, the method characterized in that:
the method provides a personalized unicast distribution using a personalized transmission technique from a server to a client; and
the server changes the media channel in response to a request for channel change from the client.

2. A method comprising:
receiving a channel change request from a client;
determining client properties in response to the received request;
identifying the nearest RAP as nRAP;
identifying the nearest PCR as nPCR and the nearest sequence parameter set (SPS) as nSPS;
determining if Dist(nRAP, nSPS) is greater than Dist (nRAP, nPCR);
if Dist(nRAP, nSPS)>Dist (nRAP, nPCR) then find the nearest PSI (as nPSI) from nSPS and otherwise find the nearest PSI (as nPSI) from nPCR;
generate a personalized channel stream for the client with optional switch data; and
initiating streaming data from nPSI for the client.

3. A method as in claim 2, further comprising using throttling to reduce client buffering delay.

4. A system comprising:
an edge router receiving broadcast data from an external broadcast data source;
a fast channel change (FCC) server or appliance coupled to the edge router via a r-link,
a DSLAM coupled to the FCC server or appliance; and
the FCC server or appliance and the DSLAM interfacing to a client via a subscriber network.

5. A method for performing a unicast channel change operation between a client and a server coupled with the client, the method comprising:
sending first data over a first channel by a server to a client;
receiving first data over a first channel by the client from the server;
while the client is receiving the first data for the first channel, the client sending a channel change request to the server, to request a change to a second channel and second data different than the first channel and first data;
receiving the channel change request by the server;
in response to receipt of the channel change request, the server stopping sending first data on the first channel, and initiating sending second data on a second channel to the client;
receiving the second data on the second channel by the client from the server in response to the request to change channel sent to the server.

6. A method as in claim 5, further comprising: before receiving the request for a channel change, initializing the client device including the client device contacting the data server, and establishing a unicast channel connection between the client and the server.

7. A method as in claim 6, wherein the unicast channel connection is established using either a unicast address and port or a multicast address and port of the client.

8. A method as in claim 7, wherein the establishment of the unicast channel connection comprises the client sending a connection request to the server and identifying an internet protocol (IP) address for communication to the server.

9. A method as in claim 8, wherein the identification further includes registering the client address with the server.

10. A method as in claim 5, further comprising: sending to the server, by the client, a request to receive data corresponding to a particular channel.

11. A method as in claim 10, wherein the particular channel is a default channel assigned by the client, or by the server, or by the system, or identified by a subscriber using the client as their default channel.

12. A method as in claim 10, wherein the particular channel is a selected channel.

13. A method as in claim 10, further comprising: the server responding to the request received from the client, by switching unicast data stream delivery from the default unicast channel to the selected unicast channel and delivering the selected unicast channel data to the client.

14. A method as in claim 5, further comprising: recognizing a choice by the client from a user to choose a different channel from the current channel, and the client responding to the choice by sending a request for a channel change to the server to receive data corresponding to a chosen channel.

15. A method as in claim 5, wherein the request for a channel change is communicated from the client to the server using the substantially the reverse physical communication path as used for the communication of data from the server to the client.

16. A method as in claim 5, wherein the request for a channel change is communicated from the client to the server using a single physical communication path, over a switched or non-switched network, as the physical communications path used for the communication of data from the server to the client.

17. A method as in claim 15, wherein the single physical communication path provides for a first logical path from the server to the client, and a second logical path for communication from the client to the server.

18. A method as in claim 16, wherein the single physical communication path includes a communication path through a router and a DSLAM.

19. A method as in claim 18, wherein the request from the client to the server is made using an out-of-band logical or physical communication path different from the in-band communication path of the data stream being sent to the client.

20. A method as in claim 19, wherein the request by the client to the server to change to a second channel, is generated in response to receipt of a channel change choice command received by the client device.

21. A method as in claim 20, wherein the channel change choice command received by the client device comprises a channel change input by a subscriber viewer.

22. A method as in claim 21, further comprising: after the client begins to receive the data for the second channel, the client optionally recognizing a change in the second channel data program definition and performing a clear operation of first channel data and metadata in the client.

23. A method as in claim 22, wherein the clear operation is accomplished by a reset of a decoder in the client, the clear operation flushing or clearing data stream buffers and data stream properties present in the decoder.

24. A method as in claim 23, wherein the reset includes a soft-reset of the decoder in the client to clear the decoder previous data content

25. A method as in claim 5, further comprising: receiving the new data for the selected second channel, extracting new second channel data stream properties, and at least partially filling a data buffer before beginning a play of the second channel data so as to avoid data underflow and display artifacts caused by having insufficient second channel data to play, and sending the decoded selected second channel data for the to a display device integral with or coupled to the client device.

26. A method for performing a server-side unicast channel change operation between a client and a server coupled with the client, the method comprising:
sending first data over a first channel by a server to a client;
receiving the channel change request by the server; and
in response to receipt of the channel change request, the server stopping sending first data on the first channel, and initiating sending second data on a second channel to the client

27. A method for performing a client-side unicast channel change operation between a client and a server coupled with the client, the method comprising:
receiving first data over a first channel by the client from the server;
while the client is receiving the first data for the first channel, the client sending a channel change request to the server, to request a change to a second channel and second data different than the first channel and first data; and
receiving the second data on the second channel by the client from the server in response to the request to change channel sent to the server.

28. A system comprising:
a channel change appliance for coupling to a network and receiving an encoded data stream from the network;
a second appliance performing a function of a Digital Subscriber Line Access Multiplexer (DSLAM) receiving the communicating a plurality of output data stream to a plurality of client devices, at least one of the output data stream communicated to the plurality of client devices being a personalized unicast output data stream communicated to a particular one of the client devices;
a switch or router coupled to the channel change appliance for switching or routing at least one data stream to the second appliance; and
a communication link between the channel change appliance and the client device for communicating a channel change request signal identifying a request channel or data stream.

29. A system as in claim 28, wherein the channel change appliance comprises an FCC appliance or server.

30. A system as in claim 28, wherein the second appliance comprises a Digital Subscriber Line Access Multiplexer (DSLAM).

31. A system as in claim 28, wherein the client device comprises a set-top box coupled to a digital TV.

32. A computer program stored on a computer readable media and including instructions for execution in a processor logic to modify or control the operation of the processor logic or of a device or system in communication with the processor logic, the instructions including instructions to perform a method for performing a unicast channel change operation between a client and a server coupled with the client, the method comprising:
sending first data over a first channel by a server to a client;
receiving first data over a first channel by the client from the server;
while the client is receiving the first data for the first channel, the client sending a channel change request to the server, to request a change to a second channel and second data different than the first channel and first data;
receiving the channel change request by the server;
in response to receipt of the channel change request, the server stopping sending first data on the first channel, and initiating sending second data on a second channel to the client;
receiving the second data on the second channel by the client from the server in response to the request to change channel sent to the server.

33. A fast channel change appliance for performing a unicast channel change operation between a client and a server coupled with the client, the fast channel change appliance comprising:
means for sending first data over a first channel by a server to a client;
means receiving the channel change request by the server; and
means for controlling operation of the appliance so that in response to receipt of the channel change request, the server stopping sending first data on the first channel, and initiating sending second data on a second channel to the client.
